(19) United States
(12) Patent Application Publication
(10) Pub. No.: US 2007/0140192 A1
(43) Pub. Date: Jun. 21, 2007

(54) Mobile station in wireless LAN system, and method of guaranteeing bandwidth for the mobile station

(75) Inventors: Akiko Kusumoto, Kawasaki (JP); Kazuhiro Ichiyanagi, Kawasaki (JP); Tsuyoshi Miura, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/412,777

(22) Filed: Apr. 28, 2006

(30) Foreign Application Priority Data
Dec. 20, 2005 (JP) 2005-366422

(51) Int. Cl. H04Q 7/24

(52) U.S. Cl. 370/338; 370/395.52

(57) ABSTRACT

A bandwidth requesting unit gathers requests for a bandwidth guarantee from a plurality of data communication devices connected to a mobile station, and makes a request for bandwidths for the data communication devices collectively to a base station. A transmission control unit multiplexes packets to be transmitted from the data communication devices, and transmits the multiplexed packets to the base station, during the bandwidth guarantee time determined by the base station in response to the request from the bandwidth requesting unit.

### BACKGROUND OF THE PRESENT INVENTION

1. Field of the Present Invention

The present invention relates to a technology for guaranteeing a bandwidth for a mobile station in a wireless local-area-network (LAN) system in which a base station determines a bandwidth guarantee time in response to a request for bandwidth guarantee.

2. Description of the Related Art

In a wireless local-area-network (LAN) communication system, IEEE802.11e standard is established as a bandwidth guarantee system for realtime-based data, such as voice and moving pictures. In the wireless LAN system conforming to the IEEE802.11e standard, when individual mobile stations send a base station having a polling right, bandwidth guarantee requests based on the quality of communication for a data stream, the base station determines the bandwidth guarantee time for each of the mobile stations based on the bandwidth guarantee requests. After determination of the bandwidth guarantee time, the base station permits, only the mobile station to which polling has been made, to transmit and receive data only during the bandwidth guarantee time, while the other mobile stations withhold data transmission and reception until the base station gives a permission. Priority transmission of a data stream to each mobile station is carried out this way (see, for example, IEEE 802.11e-2005, IEEE Standard for Information Technology).

However, the IEEE802.11e standard assumes only a case where a mobile station has only one Internet-Protocol (IP) data communication device, and does not assume a case where a mobile station has a plurality of IP data communication devices. Therefore, when the mobile station has a plurality of IP data communication devices, the base station must individually guarantee the IP data communication devices for their bandwidths.

### SUMMARY OF THE PRESENT INVENTION

It is an object of the present invention to at least solve the problems in the conventional technology.

A mobile station according to one aspect of the present invention, of which a bandwidth guarantee time is determined by a base station in response to a request for bandwidth guarantee in a wireless local-area-network system, includes a bandwidth requesting unit that gathers requests for the bandwidth guarantee from a plurality of data communication devices connected to the mobile station, and makes a request for bandwidths for the data communication devices collectively to the base station; and a transmission control unit that multiplexes packets to be transmitted from the data communication devices, and transmits the multiplexed packets to the base station, during the bandwidth guarantee time determined by the base station in response to the request from the bandwidth requesting unit.

A method according to another aspect of the present invention is for guaranteeing a bandwidth for a mobile station of which a bandwidth guarantee time is determined by a base station in response to a request for bandwidth guarantee in a wireless local-area-network system. The method includes bandwidth requesting including gathering requests for the bandwidth guarantee from a plurality of data communication devices connected to the mobile station and making a request for bandwidths for the data communication devices collectively to the base station; and transmission controlling including multiplexing packets to be transmitted from the data communication devices and transmitting the multiplexed packets to the base station, during the bandwidth guarantee time determined by the base station in response to the request from the bandwidth requesting unit.

The above and other objects, features, advantages and technical and industrial significance of this invention will be better understood by reading the following detailed description of presently preferred embodiments of the present invention, when considered in connection with the accompanying drawings.

### BRIEF DESCRIPTION OF THE DRAWINGS

FIG. 1 is a schematic for illustrating a configuration of a wireless LAN system according to a first embodiment of the present invention;

FIG. 2 is a functional block diagram of a mobile station according to the first embodiment;

FIG. 3 is a schematic for illustrating a format of an RTP packet;

FIG. 4A is a table of an example of a scheduling list;

FIG. 4B is a table of an example of a bandwidth guarantee request;

FIG. 5 is a sequence diagram up to registration of bandwidth guarantee time;

FIG. 6 is a flowchart of a processing procedure for a bandwidth-guarantee-request creating process performed by a scheduling unit at step S103 shown in FIG. 5;

FIG. 7 is a timing chart of allocation of bandwidth guarantee times when priority transmission is executed;

FIG. 8A is a schematic for illustrating transmission sequences of the mobile station and a base station in the allocated times shown in FIG. 7;

FIG. 8B is a schematic for illustrating conventional transmission sequences when polling is executed for each data stream;

FIG. 9 is a functional block diagram of a mobile station according to a second embodiment of the present invention;

FIG. 10 is a flowchart of a processing procedure for a scheduling-list generating process performed by a scheduling-list generating unit;

FIG. 11 is a functional block diagram of a mobile station according to a third embodiment of the present invention; and

FIG. 12 is a timing chart for illustrating a change in allocated time when a transmission-completion notification is received.

### DETAILED DESCRIPTION OF THE PREFERRED EMBODIMENTS

Exemplary embodiments of the present invention will be explained below in detail with reference to the accompanying drawings. It should be noted that the present invention is not limited to the embodiments.

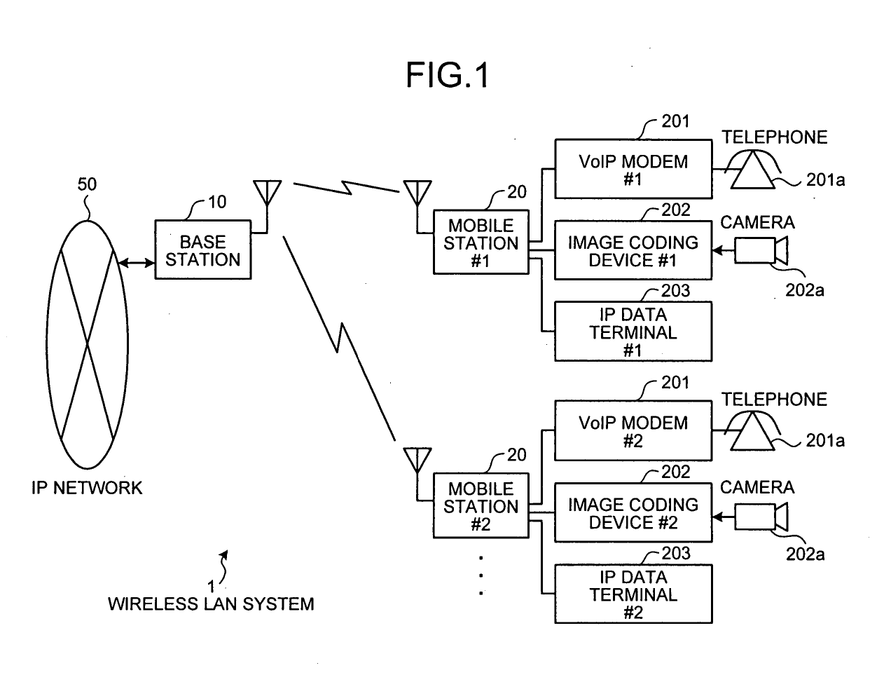

FIG. 1 is a schematic for illustrating a configuration of a wireless LAN system 1 according to a first embodiment of the present invention. The wireless LAN system 1, which conforms to the IEEE802.11e standard, includes a base station 10, and a plurality of mobile stations 20 (mobile stations #1, #2, . . . ). Hereinafter, when the mobile stations #1, #2, and so forth do not need to be distinguished from one another, each mobile station is referred to as a “mobile station 20”.

The base station 10 is an access point in the wireless LAN system 1, which relays communication between the mobile stations 20 and an IP network 50.

The mobile station 20 is a terminal station in the wireless LAN system 1. A plurality of IP data communication devices is wire-connected to the mobile station 20. A VoIP modem 201 that encodes a voice input from a telephone 201a and sends packets of voice data, an image coding device 202 that encodes an image picked up by a camera 202a and sends packets of image data, an IP data terminal 203 that sends packets of data conforming to the hyper text transport protocol (HTTP), or the like, are connected to the mobile station 20. The mobile station 20 multiplexes a collection of data of different kinds from the VoIP modem 201, the image coding device 202, and the like, and transmits the multiplexed data to the base station 10.

The multiplexed transmission of a collection of data from IP data communication devices to the base station 10 enables the mobile station 20 to send a plurality of data to the base station 10 at a time.

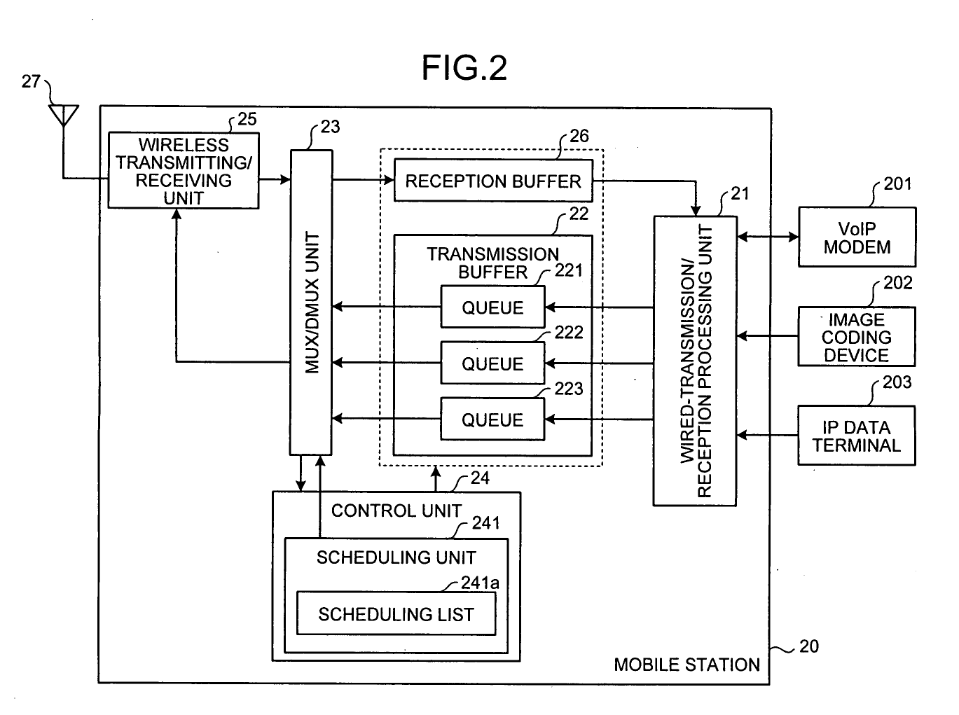

FIG. 2 is a functional block diagram of the mobile station 20 according to the first embodiment. The mobile station 20 includes a wired-transmission/reception processing unit 21, a transmission buffer 22, a multiplexing/demultiplexing (MUX/DMUX) unit 23, a control unit 24, a wireless transmitting/receiving unit 25, and a reception buffer 26.

The wired-transmission/reception processing unit 21 receives reliable transport protocol (RTP) packets or the like from the VoIP modem 201 that is wire-connected and the image coding device 202, and distributes the received RTP packets to queues 221 to 223 of the transmission buffer 22 according to data types. The wired-transmission/reception processing unit 21 transfers data stored in the reception buffer 26 to the VoIP modem 201 and the like.

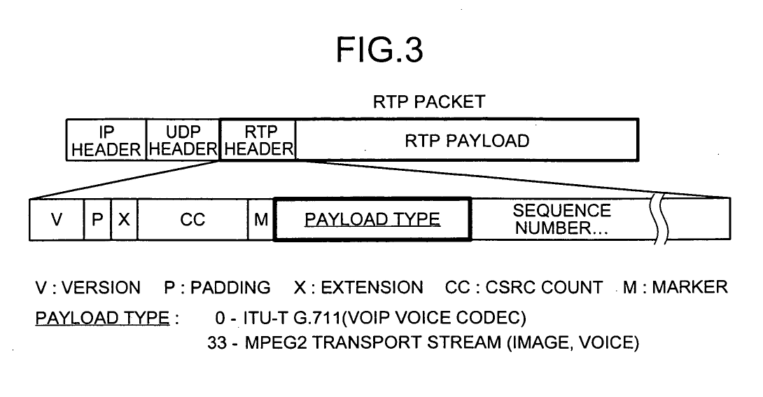

FIG. 3 is a schematic for illustrating a format of the RTP packet. The RTP packet received by the wired-transmission/reception processing unit 21 includes an RTP header and an RTP payload. The RTP header includes a version, a padding, a header extension, a CSRC (contributing source) count, a marker, a payload type, and a sequence number.

The value of the payload type is “0” for voice data from the VoIP modem 201, and is “33” for image data from the image coding device 202. The wired-transmission/reception processing unit 21 analyzes the value of the payload type to determine the data type of the packet, and distributes the packet received from the VoIP modem 201 to the queue 221, the packet received from the image coding device 202 to the queue 222, and the other types of packets conforming to the HTTP protocol to the queue 223.

The transmission buffer 22 is received by the wired-transmission/reception processing unit 21, and includes the queues 221 to 223. The MUX/DMUX unit 23 multiplexes packet data stored in the queues 221 to 223 of the transmission buffer 22 in a time divisional multiplexing form, and transfers the multiplexed packet data to the wireless transmitting/receiving unit 25. The MUX/DMUX unit 23 separates a control signal for a transmission-permitted frame from data from the base station 10 received by the wireless transmitting/receiving unit 25, and transfers the control signal to the control unit 24.

The control unit 24 controls the transmission buffer 22 and the reception buffer 26, and particularly controls multiplexing of data to be transmitted to the base station 10 by controlling data transfer from the queues 221 to 223 of the transmission buffer 22 to the MUX/DMUX unit 23.

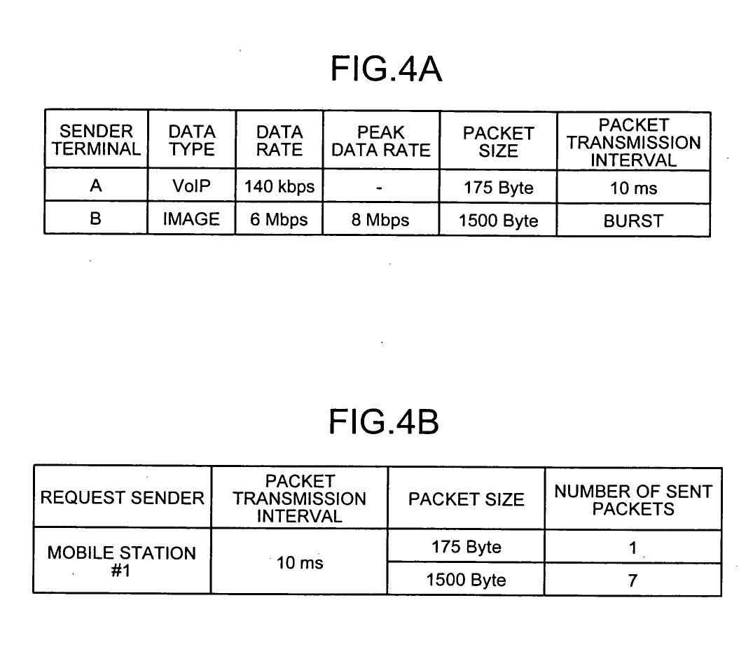

The control unit 24 includes a scheduling unit 241. The scheduling unit 241 stores information on a data stream from each IP data communication device wire-connected to the mobile station 20 as a scheduling list 241a. FIG. 4A is a table of an example of the scheduling list 241a. A media-access-control (MAC) address indicating a sender terminal, a data type, a data rate, a peak data rate, a packet size, and a packet transmission interval are recorded in the scheduling list 241a for each of the IP data communication devices wire-connected to the mobile station 20.

In the scheduling list 241a, data to be sent from, for example, the VoIP modem 201 indicates that the sender terminal is “A”, the data type is “VoIP”, the data rate is “140 kilobytes per second”, the packet size is “175 bytes”, and the packet transmission interval is “10 microseconds”. The peak data rate is set only when a burst transmission is performed in which case “burst” is recorded in the packet transmission interval.

The scheduling unit 241 creates a bandwidth guarantee request based on the scheduling list 241a, and transmits the created bandwidth guarantee request to the base station 10 via the MUX/DMUX unit 23 and the wireless transmitting/receiving unit 25. The bandwidth guarantee request is used to determine the bandwidth guarantee time which is allocated to the mobile station 20 by the base station 10. During the bandwidth guarantee time, the base station 10 permits only one of the mobile stations 20 (the mobile station #1) to transmit data.

FIG. 4B is a table of an example of the bandwidth guarantee request. The bandwidth guarantee request includes a request sender, a packet transmission interval, one or plural types of packet sizes, and the number of packets sent for each packet size. For example, in FIG. 4B, the mobile station #1 transmits a collection of a packet with a packet size of “175 bytes” and seven packets with a packet size of “1500 bytes” to the base station 10 in the packet transmission interval of 10 microseconds. Based on the bandwidth guarantee request, the base station 10 computes the time during which the mobile station 20 can send all the packets within the packet transmission interval and sets the time as the bandwidth guarantee time for the mobile station 20.

After the base station 10 has determined the bandwidth guarantee time based on the bandwidth guarantee request transmitted from the mobile station 20, the control unit 24 of the mobile station 20 controls the number of packets to be transferred to the MUX/DMUX unit 23 from the queues 221 to 223 of the transmission buffer 22, and the transfer timing based on the scheduling list 241a, so that packet data can be properly multiplexed and transmitted within the determined bandwidth guarantee time.

Since the scheduling unit 241 creates the bandwidth guarantee request based on the scheduling list 241a, and the control unit 24 multiplexes the packets stored in the queues 221 to 223 based on the scheduling list 241a, the mobile station 20 can request the base station 10 for the bandwidths at a time.

The wireless transmitting/receiving unit 25 performs wireless communications with the base station 10 via an antenna 27. The reception buffer 26 stores packet data received from the wireless transmitting/receiving unit 25, and sends the received data to the wired-transmission/reception processing unit 21.

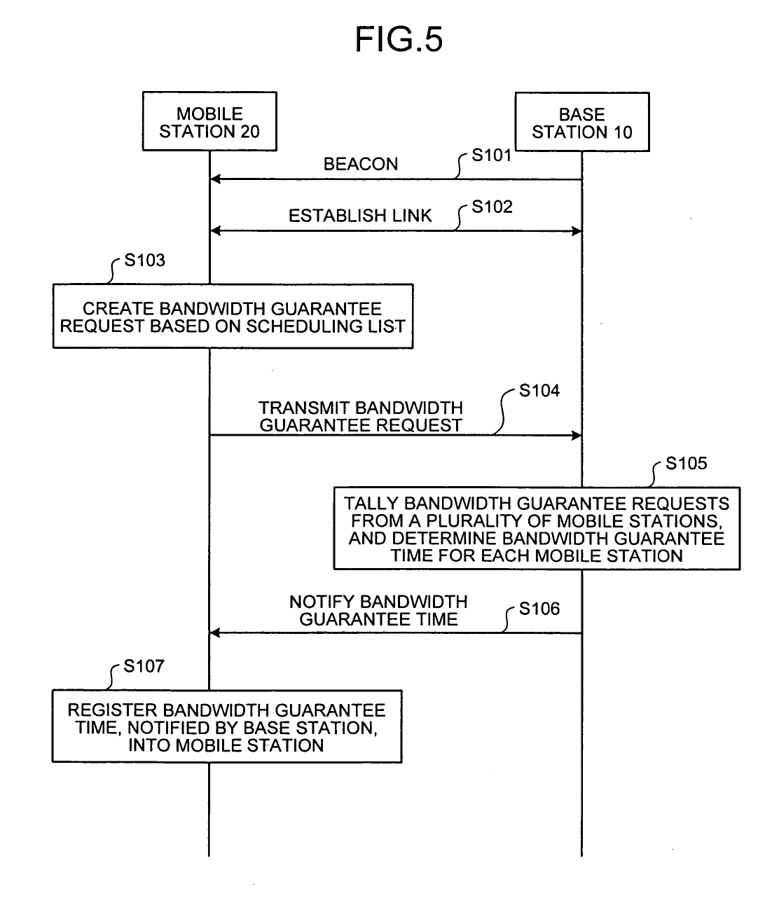

FIG. 5 is a sequence diagram up to registration of the bandwidth guarantee time. Although only one mobile station 20 is shown in FIG. 5, the base station 10 actually performs wireless communications with a plurality of mobile stations 20, and performs similar processes.

The base station 10 sends a beacon to inform the mobile station 20 of the presence of the base station 10 (step S101). When detecting the beacon, the mobile station 20 starts a wireless communication with the base station 10, and establishes a link thereto (step S102).

When a predetermined time elapses and the communication state becomes stable, the scheduling unit 241 of the mobile station 20 creates a bandwidth guarantee request shown in FIG. 4B based on the scheduling list 241a shown in FIG. 4A (step S103), and transmits the bandwidth guarantee request to the base station 10 (step S104).

The base station 10 tallies the bandwidth guarantee requests from each of the mobile stations 20, and determines the bandwidth guarantee time of each of the mobile stations 20 (step S105), and notifies the mobile station 20 of the determination result (step S106). The mobile station 20 registers the bandwidth guarantee time notified from the base station 10 (step S107), and thereafter transmits packets to the base station 10 during the bandwidth guarantee time.

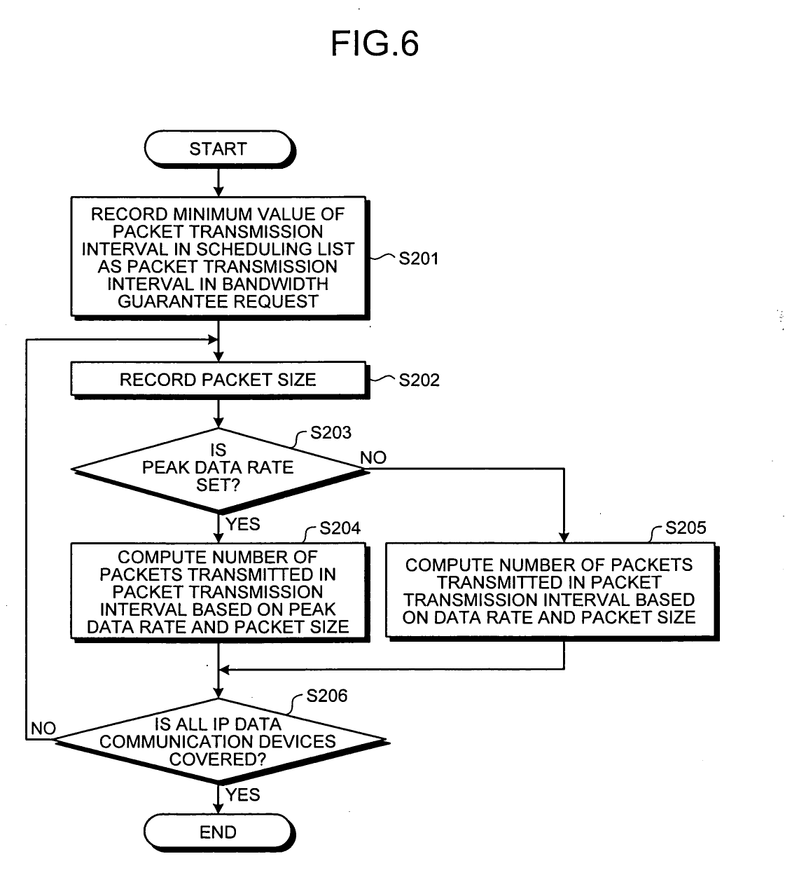

FIG. 6 is a flowchart of a processing procedure for a bandwidth-guarantee-request creating process performed by the scheduling unit 241 at step S103 shown in FIG. 5. The scheduling unit 241 acquires a minimum value of packet transmission intervals of the IP data communication devices recorded in the scheduling list 241a, and stores the value as the packet transmission interval in the bandwidth guarantee request (step S201). In the example shown in FIG. 4A, the packet transmission interval is “10 microseconds”.

Thereafter, the scheduling unit 241 executes the process at step S202 and subsequent steps by the number of the IP data communication devices. First, the scheduling unit 241 stores the packet size sent from one IP data communication device (step S202), and determines whether the peak data rate is set in the IP data communication device (step S203).

When the peak data rate is set, the scheduling unit 241 computes the number of packets to be transmittable during the packet transmission interval, acquired at step S201, based on the peak data rate and the packet size (step S204). For example, if data is from the IP data communication device whose sender terminal is “B” in FIG. 4A, since the peak data rate is set, the number of packets to be transmitted in the packet transmission interval is computed as
8000000÷(1500×8)×(10/1000)≈6.66,
which is rounded to “7”, from the peak data rate (8 megabytes per second), the packet size (1500 bytes) and the packet transmission interval (10 microseconds) determined at step S201.

When the peak data rate is not set, the scheduling unit 241 computes the number of packets to be transmittable during the packet transmission interval, acquired at step S201, based on the data rate and the packet size (step S205). For example, if data is from the IP data communication device whose sender terminal is “A”, since the peak data rate is not set, the number of packets to be transmitted in the packet transmission interval is computed to be “1” from the data rate (140 kilobytes per second), the packet size (175 bytes), and the packet transmission interval (10 microseconds) determined at step S201.

The collection of the packet transmission interval thus determined, the packet sizes and the packet transmission numbers for the respective data types is the bandwidth guarantee request shown in FIG. 4B. The scheduling unit 241 transmits the bandwidth guarantee request to the base station 10 via the MUX/DMUX unit 23 and the wireless transmitting/receiving unit 25.

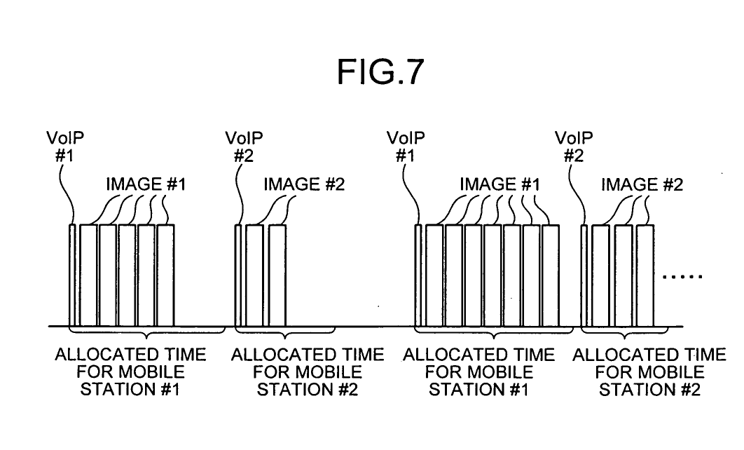

FIG. 7 is a timing chart of allocation of bandwidth guarantee times when priority transmission is executed. The base station 10 determines the bandwidth guarantee time for each of the mobile stations 20 based on the bandwidth guarantee requests from the mobile stations 20 (mobile station #1, mobile station #2, . . . ), and notifies the mobile stations 20 of the results.

The base station 10 determines the allocation of bandwidth guarantee time for each of the mobile stations 20, and then permits data transmission to the mobile stations 20 according to the allocation of the determined bandwidth guarantee times. In FIG. 7, the bandwidth guarantee times are allocated in the order of the mobile station #1 and the mobile station #2, and the base station 10 permits data transmission in the order of the mobile station #1 and the mobile station #2.

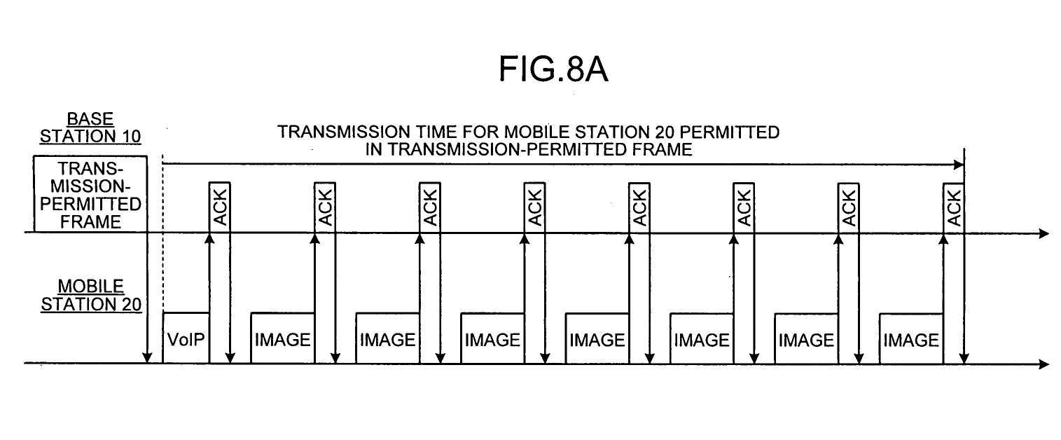

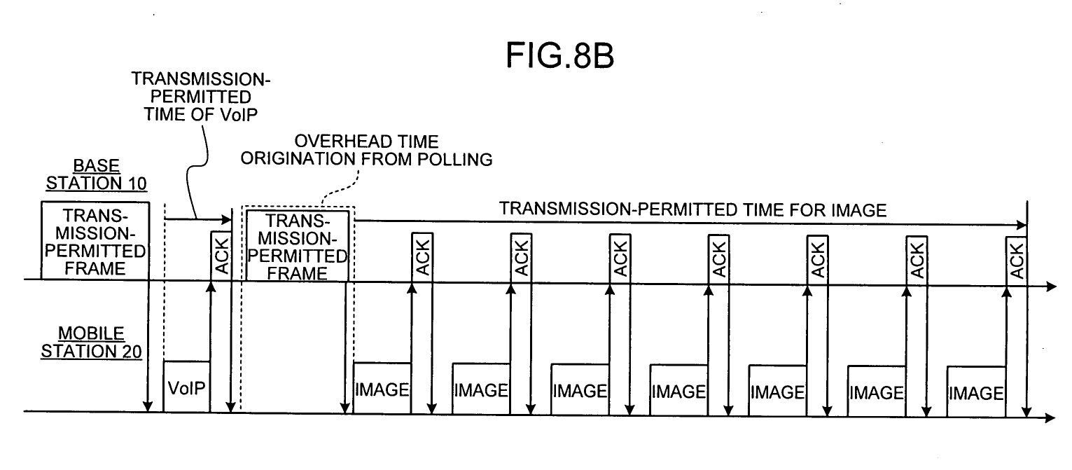

FIG. 8A is a schematic for illustrating transmission sequences of the mobile station 20 and the base station 10 in the allocated times shown in FIG. 7. A time during which one packet from the VoIP modem 201 and seven packets from the image coding device 202 can be transmitted is allocated as the bandwidth guarantee time for the mobile station 20. The base station 10 transmits a transmission-permitted frame to the mobile station 20, thereby permitting data transmission from the mobile station 20 to the base station 10 only for the bandwidth guarantee time.

The time required to transmit data, as the bandwidth guarantee time, is determined based on the bandwidth guarantee request as shown in FIG. 4B with the peak data rate taken as a reference. With reference to FIG. 8A, when the transfer speed of a wireless line is 54 megabytes per second, the time during which one packet from the VoIP modem 201 and seven packets from the image coding device 202 can be transmitted is simply computed as
(175+1500×7)×8÷54000000≈0.0016 (μs).
The bandwidth guarantee time for the mobile station 20 is this value plus the overhead time due to the wireless headers added to the packets, the transmission time for acknowledgement (ACK), and the frame interval (short inter-frame space (SIFS)) according to the number of packets to be transmitted. Accordingly, the mobile station 20 can transmit even data that is subject to burst transmission at the peak data rate to the base station 10 without delay.

FIG. 8B is a schematic for illustrating conventional transmission sequences when polling is executed for each data stream. With a structure in which polling is performed for each data stream, even when a packet from the VoIP modem 201 and a packet from the image coding device 202 are continuously transmitted from the same mobile station 20, the base station 10 performs polling on the same mobile station 20 twice in succession. For the transmission-permitted frame for a packet from the image coding device 202, therefore, there is an overhead as seen from the mobile station 20 side.

When data streams of different types are transmitted from the same mobile station 20, therefore, as shown in FIG. 8A, the mobile station 20 requests the base station 10 beforehand for the bandwidth guarantee time in which a plurality of data streams can be transmitted, and transmits a collection of data streams to the base station 10 in the bandwidth guarantee time determined based on the request, thereby shortening the overhead time as seen from the mobile station 20 side.

As described above, according to the first embodiment, the scheduling unit 241 transmits a collection of bandwidth guarantee requests about a plurality of IP data communication devices to the base station 10, and the control unit 24 multiplexes packets stored in the queues 221 to 223 of the transmission buffer 22 and transmits the multiplexed packets to the base station 10 during the bandwidth guarantee time allocated to the mobile station 20 by the base station 10. Accordingly, the mobile station 20 can request the base station 10 for bandwidths at a time, thereby improving the transmission efficiency in priority transmission.

According to the first embodiment, a scheduling list is preset by a user. However, the scheduling list need not be set by the user, and can be generated automatically by a mobile station. According to a second embodiment of the present invention, a mobile station that automatically generates a scheduling list is explained.

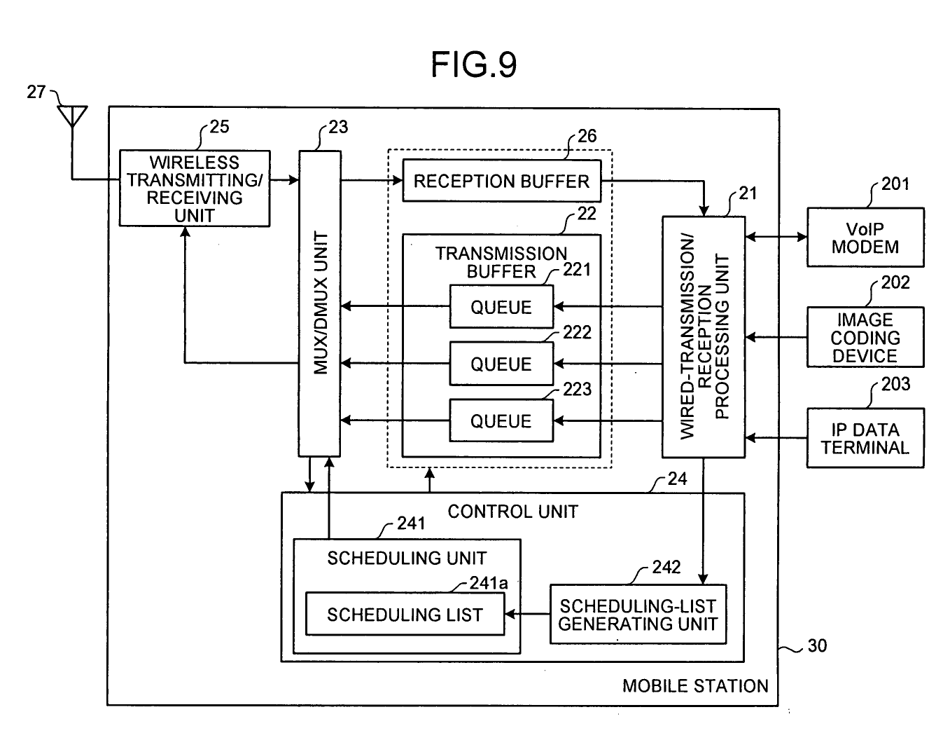

FIG. 9 is a functional block diagram of a mobile station 30 according to the second embodiment. For the sake of descriptive convenience, like reference numerals designate like functional portions that perform similar operations to those of the corresponding portions shown in FIG. 2, and detailed explanations are omitted.

The control unit 24 in the mobile station 30 includes the scheduling unit 241 and a scheduling-list generating unit 242. The scheduling-list generating unit 242 automatically generates the scheduling list 241a. The scheduling-list generating unit 242 detects the data type, the packet size, and the packet reception time interval of a packet received by the wired-transmission/reception processing unit 21, tallies those pieces of information for a predetermined time for each IP data communication device, and generates the scheduling list 241a based on the result of the tally.

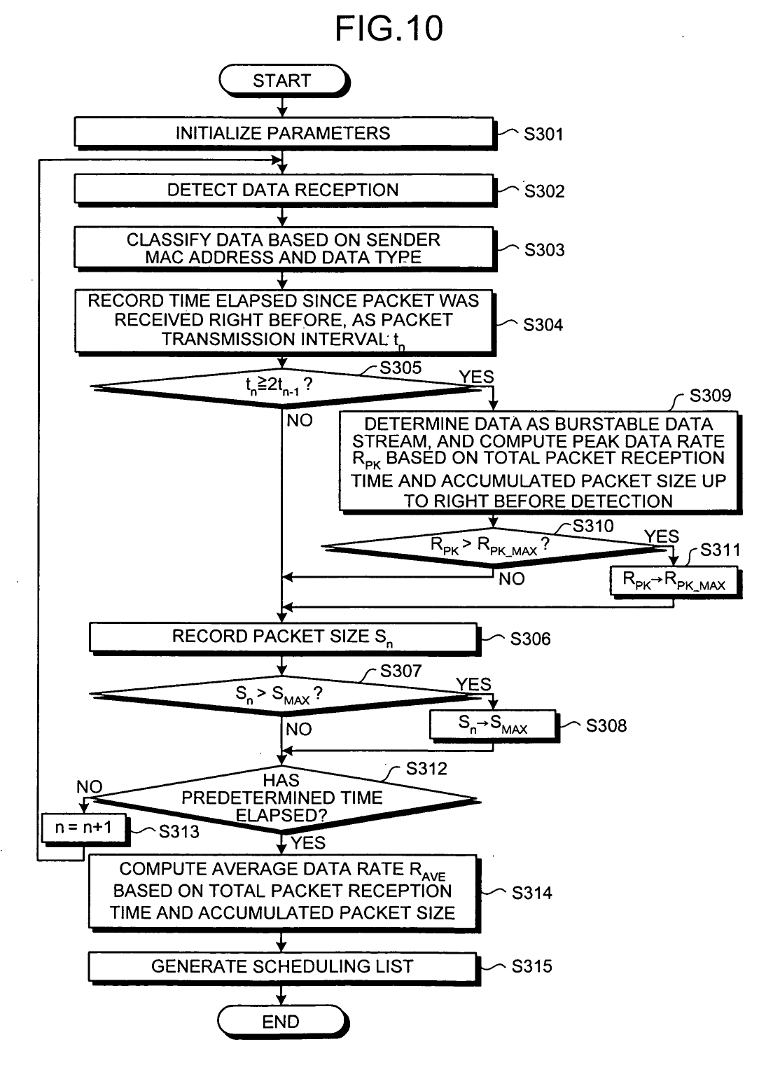

FIG. 10 is a flowchart of a processing procedure for a scheduling-list generating process performed by the scheduling-list generating unit 242.

The scheduling-list generating unit 242 initializes parameters, such as a counter value n, a maximum packet size S_{MAX}, and a maximum peak data rate R_{PK}_{_{—}}_{MAX} (step S301) When detecting that the wired-transmission/reception processing unit 21 has received a packet (step S302), the scheduling-list generating unit 242 classifies the packet based on a sender MAC address and the data type (step S303), and at step S303 and subsequent steps, records the packet size, the packet transmission interval, and the like for each of types of packets classified at step S303.

The scheduling-list generating unit 242 records the time elapsed since the packet was received right before a packet as a packet transmission interval tₙ (step S304), and determines whether the packet transmission interval tₙ is equal to or greater than twice a packet transmission interval tₙ₋₁ which is recorded right before (step S305). It is to be noted that when n=0, processes at steps S304 and S305 are omitted, whereas when n=1, the determination at step S305 is omitted.

At step S305, the values of two packet transmission intervals tₙ and tₙ₋₁ are compared with each other to determine whether the packet that has been received when the packet transmission interval tₙ₋₁ was recorded, has been burst-transmitted. When tₙ is less than twice tₙ₋₁, the scheduling-list generating unit 242 determines that burst transmission has not occurred, and proceeds to step S306 and subsequent steps.

The scheduling-list generating unit 242 records the packet size Sₙ of data received at step S302 (step S306) determines whether the value of the packet size Sₙ is greater than the maximum packet size S_{MAX} (step S307), and updates the value of the maximum packet size S_{MAX} when Sₙ is greater than S_{MAX} (step S308).

When it is determined at step S305 that tₙ is equal to or greater than twice tₙ₋₁, the scheduling-list generating unit 242 determines that the data is a burstable data stream, and computes a peak data rate R_{PK} based on the total packet reception time and the accumulated packet size up to right before detection of burst transmission (step S309). That is, the peak data rate R_{PK} is calculated as
R_{PK}=(S₀+S₁+S₂+ . . . Sₙ₋₁)/(t₁+t₂+ . . . tₙ₋₁) (1)

The scheduling-list generating unit 242 determines whether the computed peak data rate R_{PK} is greater than the maximum peak data rate R_{PK}_{_{—}}_{MAX} (step S310), and updates the value of the maximum peak data rate R_{PK}_{_{—}}_{MAX} when R_{PK} is greater than R_{PK}_{_{—}}_{MAX} (step S311) before proceeding to step S306.

The scheduling-list generating unit 242 then determines whether a predetermined time sufficient to acquire stable values for the parameters has elapsed (step S312). Until the predetermined time elapses, the scheduling-list generating unit 242 increments the value of n (step S313), and returns to step S302 to repeat detection of packet data.

When the predetermined time has elapsed and stable values for the parameters are acquired, the scheduling-list generating unit 242 computes an average data rate R_{AVE} based on the total packet reception time and the accumulated packet size (step S314).

The scheduling-list generating unit 242 generates the scheduling list 241a based on the acquired parameters (step S315). The scheduling-list generating unit 242 records the sender terminal and the data type for each IP data communication device, and records the value of the average data rate R_{AVE} as “data rate”, the value of the maximum peak data rate R_{PK}_{_{—}}_{MAX} as “peak data rate”, and the value of the maximum packet size S_{MAX} as “packet size” in the scheduling list 241a. As the “packet transmission interval” in the scheduling list 241a, the scheduling-list generating unit 242 records the average value of t₁ to tₙ when the peak data rate is not computed, and records “burst” when the peak data rate is computed.

As described above, according to the second embodiment, since the scheduling-list generating unit 242 classifies packets, received by the wired-transmission/reception processing unit 21 for each type, and generates the scheduling list 241a based on the acquired packet sizes and the packet transmission intervals, the mobile station 30 can automatically extract the bandwidth guarantee request, thereby improving the convenience in priority transmission.

According to the first and the second embodiments, once the bandwidth guarantee time is determined by the base station, the bandwidth guarantee time allocated to the mobile station is always constant. When there is some bandwidth guarantee time left even after the mobile station finishes transmitting all the packets to be transmitted within the bandwidth guarantee time, the mobile station can return the bandwidth guarantee time. According to a third embodiment of the present invention, a wireless LAN system in which a mobile station can return the bandwidth guarantee time allocated by the base station is explained.

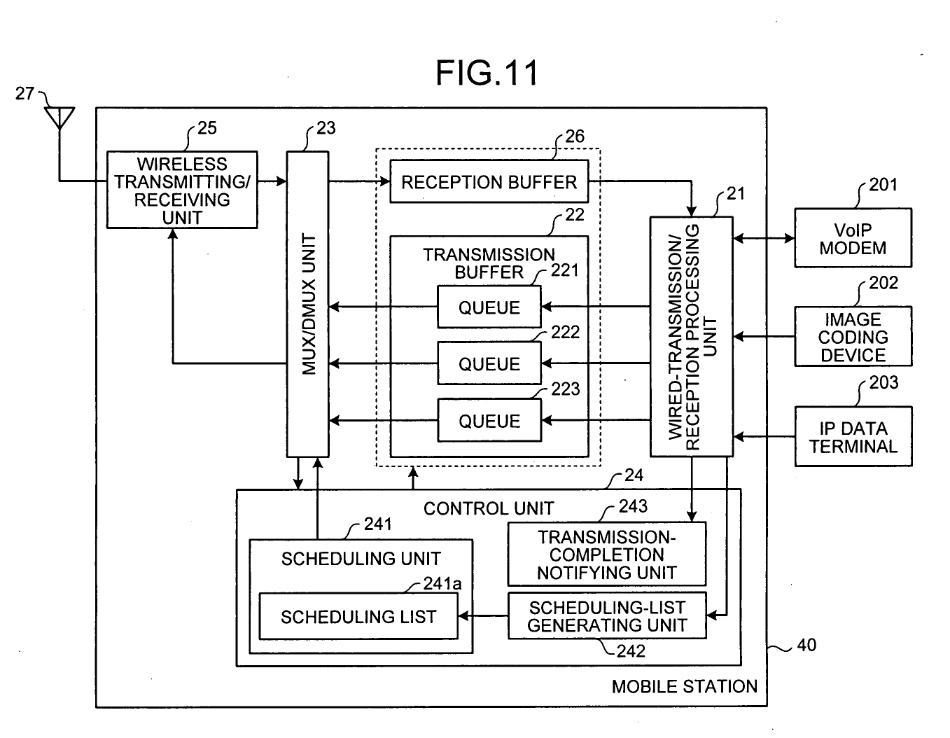

FIG. 11 is a functional block diagram of a mobile station 40 according to the third embodiment. The control unit 24 of the mobile station 40 includes the scheduling unit 241, the scheduling-list generating unit 242, and a transmission-completion notifying unit 243. The transmission-completion notifying unit 243 notifies the base station 10 of the end of transmission of a packet from the mobile station 40 and returns the bandwidth guarantee time for the mobile station 40. Upon reception of the transmission-completion notification from the transmission-completion notifying unit 243, the base station 10 cancels bandwidth guarantee to the mobile station 40, and performs polling to other mobile stations 40, ahead of schedule.

Some of the image coding devices 202 have a property of performing burst-transmission of data at every seam of a picture in an image frame for priority transmission of image data. The image coding device 202 having such a property does not perform data transmission for a while after transmitting a seam of the picture, so that the packet transmission interval until next data transmission becomes longer than the normal packet transmission interval. Even when bandwidth guarantee to the mobile station 40 is canceled right after the mobile station 40 has transmitted a seam of the picture, the reception terminal that receives this data can reproduce an image without any problem.

The transmission-completion notifying unit 243 analyzes the packet received by the wired-transmission/reception processing unit 21, and generates a transmission-completion notification when detecting reception of a seam of the picture from the image coding device 202. The control unit 24 transfers the transmission-completion notification to the transmission buffer 22, and inserts the transmission-completion notification right after a packet indicative of a seam of the picture.

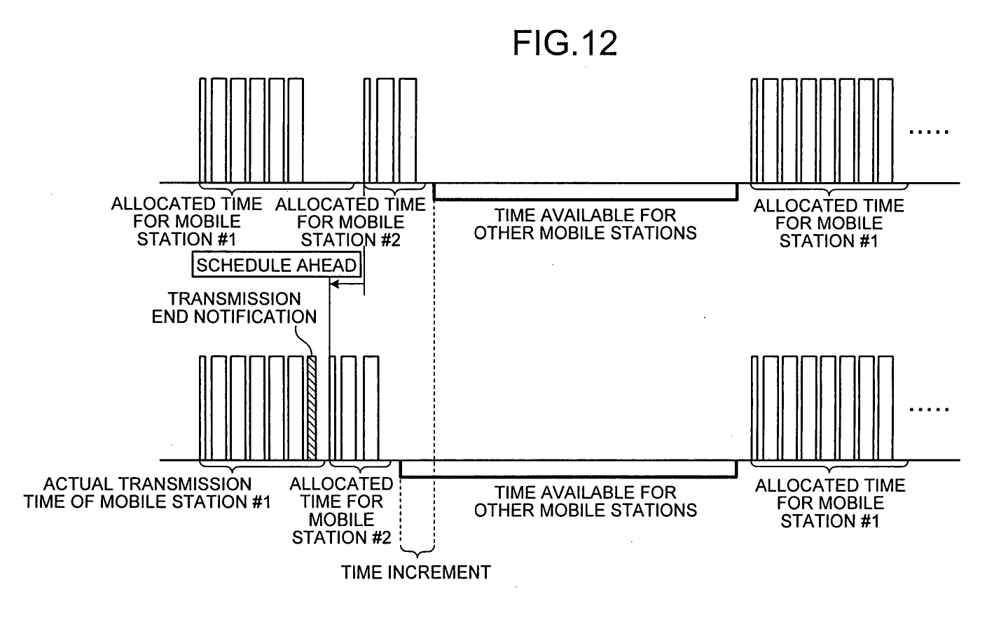

FIG. 12 is a timing chart for illustrating a change in allocated time when the transmission-completion notification is received. Upon detection of a transmission-completion notification transmitted from the mobile station #1, the base station 10 cancels bandwidth guarantee to the mobile station #1 that has transmitted the transmission-completion notification, and performs polling to the other mobile stations #2 ahead.

Since the mobile station 40 transmits the transmission-completion notification to the base station 10, the mobile station 40 can return the bandwidth guarantee time allocated by the base station 10. The base station 10 can increase the time to be allocated to wireless communications with the other mobile stations 40 and other terminal devices that have no bandwidths guaranteed as much as the time scheduled ahead as a result of return of the bandwidth guarantee time.

As described above, according to the third embodiment, the transmission-completion notifying unit 243 analyzes a packet received by the wired-transmission/reception processing unit 21 and upon detection of a seam of the picture from the image coding device 202, generates a transmission-completion notification to notify the base station 10 of the end of packet transmission, and the base station 10 cancels bandwidth guarantee to the mobile station 40 when receiving the transmission-completion notification, and performs polling to the other mobile stations 40 ahead of schedule. Therefore, the transmission efficiency in priority transmission can be improved.

Although the transmission-completion notifying unit 243 detects a seam of the picture from the image coding device 202 in the third embodiment, some of the image coding devices 202 can have a property of performing burst transmission of data every time a voice frame is transmitted for priority transmission of voice data, so that the transmission-completion notifying unit 243 can detect a voice frame instead of a seam of the picture. The reception terminal that receives this data can reproduce voices without any problem, further improving the transmission efficiency in priority transmission.

According to an embodiment of the present invention, since the mobile station can request the base station for bandwidths at a time, the transmission efficiency in priority transmission can be improved.

Furthermore, according to an embodiment of the present invention, since the mobile station can automatically extract a request for bandwidth guarantee, the convenience in priority transmission can be improved.

Moreover, according to an embodiment of the present invention, since bandwidth guarantee for other mobile stations is scheduled ahead, the transmission efficiency in priority transmission can be further improved.

Although the present invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A mobile station of which a bandwidth guarantee time is determined by a base station in response to a request for bandwidth guarantee in a wireless local-area-network system, the mobile station comprising:
a bandwidth requesting unit that gathers requests for the bandwidth guarantee from a plurality of data communication devices connected to the mobile station, and makes a request for bandwidths for the data communication devices collectively to the base station; and
a transmission control unit that multiplexes packets to be transmitted from the data communication devices, and transmits the multiplexed packets to the base station, during the bandwidth guarantee time determined by the base station in response to the request from the bandwidth requesting unit.

2. The mobile station according to claim 1, further comprising:
a bandwidth-request extracting unit that analyzes packets to be transmitted from the data communication devices, and extracts a request for the bandwidth guarantee for each of the data communication devices, wherein
the bandwidth requesting unit requests the bandwidth guarantee to the base station based on a result of extraction by the bandwidth-request extracting unit.

3. The mobile station according to claim 1, wherein
at least one of the data communication devices is an image coding device, and
the mobile station further comprises a bandwidth-return notifying unit that notifies, when a break of a picture in an image frame is detected from a packet transmitted from the image coding device, a return of the bandwidth guarantee time to the base station.

4. The mobile station according to claim 1, wherein
at least one of the data communication devices is an image coding device, and
the mobile station further comprises a bandwidth-return notifying unit that notifies, when a voice frame is detected from a packet transmitted from the image coding device, a return of the bandwidth guarantee time to the base station.

5. The mobile station according to claim 1, wherein
the bandwidth guarantee conforms to IEEE802.11e standard.

6. A method of guaranteeing a bandwidth for a mobile station of which a bandwidth guarantee time is determined by a base station in response to a request for bandwidth guarantee in a wireless local-area-network system, the method comprising:
bandwidth requesting including gathering requests for the bandwidth guarantee from a plurality of data communication devices connected to the mobile station and making a request for bandwidths for the data communication devices collectively to the base station; and
transmission controlling including multiplexing packets to be transmitted from the data communication devices and transmitting the multiplexed packets to the base station, during the bandwidth guarantee time determined by the base station in response to the request from the bandwidth requesting unit.

7. The method according to claim 6, further comprising:
bandwidth-request extracting including analyzing packets to be transmitted from the data communication devices and extracting a request for the bandwidth guarantee for each of the data communication devices, wherein
the bandwidth requesting includes requesting the bandwidth guarantee to the base station based on a result of extraction at the bandwidth-request extracting.

8. The method according to claim 6, wherein
at least one of the data communication devices is an image coding device, and
the method further comprises notifying, when a break of a picture in an image frame is detected from a packet transmitted from the image coding device, a return of the bandwidth guarantee time to the base station.

9. The method according to claim 6, wherein
at least one of the data communication devices is an image coding device, and
the method further comprises notifying, when a voice frame is detected from a packet transmitted from the image coding device, a return of the bandwidth guarantee time to the base station.

10. The method according to claim 6, wherein
the bandwidth guarantee conforms to IEEE802.11e standard.
